(19) United States
(12) Patent Application Publication
(10) Pub. No.: US 2003/0003832 A1
(43) Pub. Date: Jan. 2, 2003

(54) Cleaning sheets comprising a fibrous web of carded staple fibers hydroentangled with a reinforcing fibrous web

(75) Inventors: Stephen Lee Childs, Cincinnati, OH (US); Jodi Lynn Russell, Hayward, CA (US); Patrick Anthony Palumbo, Fairfield, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/174,895

(22) Filed: Jun. 19, 2002

Related U.S. Application Data
(60) Provisional application No. 60/302,332, filed on Jun. 29, 2001.

(51) Int. Cl. A47L 13/20; B08B 7/00; D04H 1/00; D04H 3/00

(52) U.S. Cl. 442/381; 15/228; 15/231; 15/208; 134/6; 442/408; 442/401; 442/340

(57) ABSTRACT

A cleaning sheet for removing particulate matter from a surface comprises a substrate comprising a first fibrous web comprising carded staple fibers and a reinforcing fibrous web comprising fibers selected from the group consisting of thermal bonded fibers, meltblown fibers, hydroentangled fibers, and spunbonded fibers. The first fibrous web is hydroentangled with the reinforcing fibrous web to form the substrate. The resulting cleaning sheet has a CD elongation of less than about 100% at a load of 500 grams. The cleaning sheet is preferably free of a scrim material and can further comprise an optional additive material. A method of removing particulate matter from a surface comprises contacting the surface with a cleaning sheet of the present invention.

### CROSS REFERENCE TO RELATED APPLICATIONS

This application claims priority under 35 U.S.C. §119(e) to U.S. Provisional Application Serial No. 60/302,332, filed Jun. 29, 2001 (Attorney Docket No. 8620P).

### TECHNICAL FIELD

The present invention relates to cleaning sheets particularly suitable for removal and entrapment of dust, lint, hair, sand, food crumbs, grass and the like.

### BACKGROUND OF THE INVENTION

The use of nonwoven sheets for dry dust-type cleaning is known in the art. Such sheets typically utilize a composite of fibers wherein the fibers are bonded together via adhesive, thermal bonding, entangling or other forces. See, for example, U.S. Pat. Nos. 3,629,047 and 5,144,729. To provide a durable wiping sheet, reinforcement means have been combined with staple fibers in the form of a continuous filament or network structure. See, for example, U.S. Pat. Nos. 4,808,467, 3,494,821 and 4,144,370. Also, to provide a product capable of withstanding the rigors of a wiping process, prior nonwoven sheets have employed strongly bonded fibers via one or more of the forces mentioned above. While durable materials are obtained, such strong bonding may adversely impact the materials' ability to pick up and retain particulate dirt.

In an effort to address this concern, U.S. Pat. No. 5,525,397 issued Jun. 11, 1996 to Shizuno et al., describes a cleaning sheet comprising a polymeric network layer (i.e. scrim material) and at least one nonwoven fiber layer, wherein the two layers are lightly hydroentangled so as to provide a sheet having a specific low entanglement coefficient, elongation, and breaking strength. The resulting sheet is said to provide strength and durability, as well as improved dust collecting performance because the composite fibers are lightly hydroentangled. While the sheets described in the '397 patent are alleged to address some of the problems with prior nonwoven cleaning sheets, those sheets appear to consist of fibers having a generally uniform denier and the sheets made of such fibers appear to be generally of a uniform basis weight, at least on a macroscopic level; and are essentially of a uniform caliper, again on a macroscopic level. The result of a sheet made of fibers having a uniform denier and having a uniform basis weight is that the material is not particularly suitable for collecting and entrapping soil of a diverse size, shape, etc.

To improve the suitability of cleaning sheets to collect and entrap soil of diverse size, PCT Application WO 98/52458, assigned to The Procter & Gamble Co., teaches that by providing increased three-dimensionality, in the macroscopic sense, to cleaning sheets, enhanced soil removal is achieved. This three-dimensionality can be achieved by the use of materials which provide contractile forces within the body of the sheet. These contractile forces can cause the layer or layers of the sheet to fold into relatively random peaks and valleys. These peaks and valleys provide a diverse set of collection surfaces within the sheet. It appears that the cleaning sheets are comprised of fibers having a generally uniform denier, particularly a denier of less than about 4.0. The sheets can include a polymeric net, or scrim material, to enhance the integrity of the resulting cleaning sheets.

Although polymeric nets or scrim materials can be useful in cleaning sheets to provide caliper, strength and integrity, polymeric netting or scrim materials tend to be rather difficult to process, and thus it can be troublesome to manufacture cleaning sheets comprising such polymeric nets or scrim materials. It has thus been desired to provide an improved cleaning sheet with sufficient caliper, integrity and strength having an effective ability to remove particulate matter from a surface, without the need to incorporate a polymeric netting or scrim material into the cleaning sheet.

Accordingly, it is an object of the present invention to provide an improved cleaning sheet that effectively removes and retains particulate material from surfaces, while being thick enough and strong enough to withstand the rigors of a typical household cleaning process, even without the incorporation of a polymeric net or scrim material in the structure of the cleaning sheet.

### SUMMARY OF THE INVENTION

The present invention relates to a cleaning sheet for removing particulate matter, such as dust or dirt, from a surface, the cleaning sheet comprising a substrate comprising a first fibrous web comprising carded staple fibers and a reinforcing fibrous web comprising fibers selected from the group consisting of thermal bonded fibers, meltblown fibers, hydroentangled fibers, and spunbonded fibers. The first fibrous web is hydroentangled with the reinforcing fibrous web to form the substrate. The resulting cleaning sheet has a CD elongation of less than about 100%, preferably less than about 70%, and more preferably less than about 50%, at a load of 500 grams. The reinforcing fibrous web provides the cleaning sheet with sufficient strength and integrity to effectively removing particulate matter from surfaces. The resulting cleaning sheet is therefore sufficiently strong and has sufficient integrity for cleaning household surfaces therewith, even when the cleaning sheet is free of a scrim material.

In a preferred embodiment, the substrate comprises first fibers and second fibers, wherein said first fibers and said second fibers have different denier, and wherein said cleaning sheet has a caliper of from about 0.3 to about 3 mm, preferably at least about 1 mm. In general, the first fibers will have a denier of from about 0.5 to about 15 and the second fibers have a denier of from about 0.5 to about 15, wherein the difference between the denier of the first fibers and the denier of the second fibers is at least about 0.5. Caliper of the cleaning sheet can be important, for both cleaning performance and aesthetics. The cleaning sheets of the present invention exhibit desirable caliper, even without the inclusion of a scrim material. The combination of fibers having relatively high denier with fibers having relatively low denier can provide the cleaning sheet with the desired caliper. As a result, the present cleaning sheets are thus preferably free of a scrim material.

The present invention further relates to a cleaning implement comprising a handle and a mop head for attaching the present cleaning sheets thereto.

The present invention further relates to methods of removing particulate matter from surfaces by contacting the surfaces with the cleaning sheets of the present invention.

### DETAILED DESCRIPTION OF THE INVENTION

I. Definitions

As used herein, the term “comprising” means that the various components, ingredients, or steps, can be conjointly employed in practicing the present invention. Accordingly, the term “comprising” encompasses the more restrictive terms “consisting essentially of” and “consisting of”.

As used herein, the term “hydroentanglement” means generally a process for making a material wherein a layer of loose fibrous material (e.g., polyester) is supported on an apertured patterning member (e.g. forming belt) and is subjected to water pressure differentials sufficiently great to cause the individual fibers to entangle mechanically to provide a fabric. The apertured patterning member may be formed, e.g., from a woven screen, a perforated metal plate, etc.

As used herein, the term “Z-dimension” refers to the dimension orthogonal to the length and width of the cleaning sheet of the present invention, or a component thereof. The Z-dimension usually corresponds to the thickness of the sheet.

As used herein, the term “X-Y dimension” refers to the plane orthogonal to the thickness of the cleaning sheet, or a component thereof. The X and Y dimensions usually correspond to the length and width, respectively, of the sheet or a sheet component.

As used herein, the term “layer” refers to a member or component or web of a cleaning sheet whose primary dimension is X-Y, i.e., along its length and width. It should be understood that the term layer is not necessarily limited to single layers or sheets or webs of material. Thus the layer can comprise laminates or combinations of several sheets or webs of the requisite type of materials. Accordingly, the term “layer” includes the terms “layers” and “layered.” For purposes of the present invention, an “upper” layer of a cleaning sheet is a layer that is relatively further away from the surface that is to be cleaned (i.e., in the implement context, relatively closer to the implement handle during use). The term “lower” layer conversely means a layer of a cleaning sheet that is relatively closer to the surface that is to be cleaned.

As used herein, the term “total aggregate basis weight” refers to the average basis weight of an entire cleaning sheet, when viewed as a whole sheet.

As used herein, the term “denier” refers to the number of unit weights of 0.05 grams per 450 meter length of an individual continuous fiber filament or an individual staple fiber if it were continuous.

As used herein, the term “caliper” refers to the thickness of a cleaning sheet of the present invention. Caliper can be measured using a Mitutoyo caliper gauge, which is slowly lowered onto the surface of the substrate of the cleaning sheet such that no excessive force is applied to the substrate.

As used herein, the term “CD Elongation” refers to the amount of deformation of the cleaning sheet in the cross direction caused by a tensile force of 500 grams that is applied to a 30 mm wide sample of the cleaning sheet. CD elongation is calculated as a percentage of the original sample length. The tensile force for measuring CD elongation can be applied, and CD elongation measured, using a Sintech Renew Instron 7310 device with a 100 Newton or larger load cell.

All percentages, ratios and proportions used herein are by weight unless otherwise specified. All references cited are incorporated herein by reference unless otherwise stated.

II. Cleaning Sheet

The present invention encompasses cleaning sheets comprising a substrate comprising a first fibrous web hydroentangled with a reinforcing fibrous web to improve the strength and integrity of the cleaning sheet, especially when the cleaning sheet is free of a scrim material. Applicants have found that a cleaning sheet comprising a reinforcing fibrous web can have sufficient strength and integrity for removing particulate matter from surfaces, even without the inclusion of a scrim material in the cleaning sheet. CD elongation can be an important aspect of a cleaning sheet, especially for providing sufficient strength and integrity for the cleaning sheet to be used for cleaning household surfaces, especially hardwood floors, ceramic tile, and furniture surfaces. The present cleaning sheets are able to effectively remove and retain particulate material from surfaces.

The substrates of the present cleaning sheets are formed of a first fibrous web (or layer) and a reinforcing fibrous web (or layer). The first fibrous web herein comprises carded staple fibers; and the reinforcing fibrous web herein is preferably different in type (i.e. thermal bonded fibers, meltblown fibers, spunbonded fibers, hydroentangled fibers, and the like).

The substrate of the present cleaning sheets comprises a first fibrous web (or layer) and a second reinforcing fibrous web (or layer). A reinforcing fibrous web is especially preferred wherein the first fibrous layer comprises carded staple fibers, such as carded staple polyester fibers. Carded staple fibers, while being particularly effective for removing particulate matter from surfaces, can result in a cleaning sheet without sufficient strength and integrity. The reinforcing fibrous web tends to provide enhanced strength and integrity to the resulting cleaning sheet, which is especially important when cleaning household surfaces such as hardwood floors, ceramic tile (with grout), furniture surfaces, and the like. The reinforcing fibrous web typically comprises fibers selected from the group consisting of thermal bonded fibers, meltblown fibers, spunbonded fibers, hydroentangled fibers, and mixtures thereof. The reinforcing fibrous web is preferably free of non-random perforations or open areas.

The reinforcing fibrous web herein will preferably have a denier of from about 0.5 to about 12, more preferably from about 1 to about 6, and even more preferably from about 2 to about 4.

In a preferred embodiment of the present invention, the substrate comprises at least three fibrous webs. A first fibrous web and a second fibrous web both comprise carded staple fibers, and a third reinforcing fibrous web comprises spunbonded fibers or thermal bonded fibers. The first and second fibrous webs are hydroentangled with the third fibrous web to form the substrate, preferably with the third fibrous web positioned in between the first and second fibrous webs.

The present substrates can further comprise four, five, six, or more fibrous webs (or layers).

The substrates of the cleaning sheets of the present invention typically have a total aggregate basis weight of at least about 20 g/m², preferably at least about 40 g/m², more preferably at least about 45 g/m², and even more preferably at least about 60 g/m². The total aggregate basis weight of the present cleaning sheets is typically no greater than about 200 g/m², preferably no greater than about 150 g/m², and more preferably no greater than about 100 g/m², and even more preferably no greater than about 80 g/m². Each fibrous web will typically have a basis weight of from about 25 to about 100 g/m², preferably from about 30 to about 75 gm², and more preferably from about 40 to about 50 g/m².

In the preferred embodiments that comprise a first fibrous web and a second reinforcing fibrous web, the reinforcing fibrous web will generally have a basis weight that is from about 5% to about 70%, preferably from about 10% to about 50%, and more preferably from about 15% to about 30%, of the total aggregate basis weight of the substrate of the cleaning sheet. The specific basis weight of the reinforcing layer will generally be from about 5 to about 30 g/m², and more preferably from about 10 to about 20 g/m².

While a reinforcing fibrous web can be incorporated in the substrate of the present cleaning sheet to enhance the strength and integrity of the cleaning sheet, the reinforcing fibrous web can also affect the aesthetic feel of the cleaning sheet to a consumer. For example, a reinforcing fibrous web that comprises spunbond polyester fibers tends to make the cleaning sheet more stiff compared to a reinforcing fibrous web that comprises spunbond polypropylene fibers, which makes the cleaning sheet feel softer to the touch. A cleaning sheet that does not comprise a reinforcing fibrous web tends to feel even softer to the touch, but has far less strength and integrity.

In order for the cleaning sheets to effectively clean surfaces, the cleaning sheets are sufficiently strong and not tear easily (e.g. sheet integrity). As a result, the present cleaning sheets will have a CD elongation of no greater than about 100%, preferably no greater than about 70%, and more preferably no greater than about 50%. The cleaning sheets can, however, have a certain amount of CD elongation, especially when the cleaning sheet is to be attached to a cleaning implement as described hereinafter. In this respect, a certain amount of CD elongation can be desirable, so that a consumer of the cleaning sheet can slightly stretch the cleaning sheet around the mop head of the cleaning implement and attach it to the mop head, especially when the cleaning sheet is attached to the cleaning implement via “grippers” on the mop head. The present cleaning sheets will thus preferably have a CD elongation of at least about 10%, preferably at least about 12%, and more preferably at least about 15%.

The desired CD elongation can be achieved even if the substrate of the present cleaning sheet does not comprise a scrim material. Scrim material can, however, be used to provide enhanced strength and integrity of the cleaning sheet. As used herein, the term “scrim material” refers to a polymeric netting material or a network sheet having non-random perforations therethrough, as described in U.S. Pat. No. 5,525,397, incorporated herein by reference. The present cleaning sheets are, however, preferably free of a scrim material, especially when the cleaning sheet comprises a reinforcing fibrous web as described herein.

The substrates of the present invention can be made of a variety of fibers types. Fibers particularly suitable for forming the substrates of the present cleaning sheets include, for example, natural fibers, e.g. wood pulp, cotton, wool, and the like, as well as biodegradeable fibers, such as polylactic acid fibers, and synthetic fibers such as polyolefins (e.g., polyethylene and polypropylene), polyesters, polyamides, synthetic cellulosics (e.g., RAYON®, Lyocell), cellulose acetate, bicomponent fibers, and blends thereof. Preferred starting materials for making the substrates of the cleaning sheets of the present invention are synthetic materials, which can be in the form of carded, spunbonded, meltblown, airlaid, or other structures. Particularly preferred are polyesters, especially carded polyester fibers. The degree of hydrophobicity or hydrophilicity of the fibers is optimized depending upon the desired goal of the sheet, either in terms of type of soil to be removed, the type of additive material that is provided, when an additive material is present, biodegradability, availability, and combinations of such considerations. In general, the more biodegradable materials are hydrophilic, but the more effective materials tend to be hydrophobic.

The substrates of the cleaning sheets of the present invention can be made using either a woven or nonwoven process, or by forming operations using materials laid down on forms, especially in belts, and/or by forming operations involving mechanical actions/modifications carried out on films. The structures can be made by any number of methods (e.g., spunbonded, meltblown, resin bonded, heat-bonded, air-through bonded, etc.), once the desired characteristics are known. However, the preferred structures are nonwoven, and especially those formed by hydroentanglement, since they provide highly desirable open structures. Therefore, preferred cleaning sheets are hydroentangled, nonwoven structures formed on belts and/or forming operations that include a raised three-dimensional pattern as described hereinafter.

In a preferred embodiment, the substrates of the present cleaning sheets will comprise first fibers and second fibers having different denier, the fibers typically having a denier of from about 0.5 to about 15 denier, preferably from about 0.7 to about 12, and more preferably from about 1 to about 6. The difference in denier between the first fibers and second fibers of the substrates of the present cleaning sheets will generally be at least about 0.5, preferably at least about 0.7, and more preferably at least about 1 denier. In a preferred embodiment, the first fibers will have a denier of from about 0.5 to about 2 and the second fibers will have a denier of from about 1 to about 6. Substrates comprising first and second fibers having different denier will typically enhance the caliper of the cleaning sheet, which can be important for large particulate matter pick-up cleaning performance and enhancing the particulate capacity of the cleaning sheet.

The substrates of the present cleaning sheets will preferably comprise a ratio of first fibers to second fibers of from about 100:1 to about 1:100, more preferably from about 10:1 to about 1:20, and more preferably from about 1:5 to about 1: 10, by weight.

The caliper of the resulting cleaning sheets will be from about 0.3 to about 3 mm, preferably from about 0.5 to about 2 mm, and more preferably from about 1 to about 1.8 mm. The preferred cleaning sheets herein will have a caliper of at least about 1 mm, preferably from about 1 to about 2 mm.

### Preferred Macroscopic Three-dimensionality

The cleaning sheets can be relatively planar on a macroscopic level (such as those cleaning sheets disclosed in U.S. Pat. No. 5,525,397, incorporated herein by reference) or can have macroscopic three-dimensionality (such as those cleaning sheets disclosed in co-pending U.S. application Ser. No. 09/082,396, filed May 20, 1998 by Fereshtehkhou et al., incorporated herein by reference). Preferably, the cleaning sheets exhibit macroscopic three-dimensionality which results in a cleaning sheet have greater effectiveness for removing and retaining particulate matter from surfaces. The preferred cleaning sheets exhibiting macroscopic three-dimensionality have certain characteristics such as Average Peak-to-Peak Distance, Average Height Differential, and Surface Topography Index. Such characteristics are measured according to the methods described in detail in co-pending U.S. application Ser. No. 09/082,396, filed May 20, 1998 by Fereshtehkhou et al., incorporated herein by reference.

The preferred cleaning sheets having macroscopic three-dimensionality will exhibit one or more of the following characteristics:

(a) an Average Peak-to-Peak Distance of from about 1 to about 20 mm, preferably from about 3 to about 16 mm, and more preferably from about 4 to about 12 mm;

(b) an Average Height Differential of from about 0.5 to about 6 mm, preferably from about 1 to about 3 mm, and more preferably about 1.5; and/or

(c) a Surface Topography Index of from about 0.01 to about 10, preferably from about 0.1 to about 5, more preferably from about 0.2 to about 3, still more preferably from about 0.3 to about 2.

These macroscopic three-dimensionality characteristics are described in more detail in co-pending U.S. application Ser. No. 09/082,396, filed May 20, 1998 by Fereshtehkhou et al.

### Optional Additive Material

The present cleaning sheets can further comprise an additive material affixed to the substrate. The use of a low level of additive material, uniformly attached on at least one, preferably continuous area of the sheet in an effective amount to improve the adherence of soil, especially particulates, and especially those particulates that provoke an allergic reaction, provides a surprising level of control over soil adherence. At least in those areas where the additive is present on the sheet, the low level is important for such use, since, unlike traditional dusting operations where oils are applied as liquids, or as sprays, there is much less danger of creating a visible stain, especially on such non-traditional surfaces, when the sheet is used.

The cleaning performance of any of the cleaning sheets of the present invention can be further enhanced by treating the fibers of the sheet, especially surface treating, with any of a variety of additives, including surfactants or lubricants, that enhance adherence of soils to the sheet. When utilized, such additives are added to the non-apertured cleaning sheet at a level sufficient to enhance the ability of the sheet to adhere soils. Such additives are preferably applied to the cleaning sheet at an add-on level of at least about 0.01%, more preferably at least about 0.1%, more preferably at least about 0.5%, more preferably at least about 1%, still more preferably at least about 3%, still more preferably at least about 4%, by weight. Typically, the add-on level is from about 0.1 to about 25%, more preferably from about 0.5 to about 20%, more preferably from about 1 to about 15%, still more preferably from about 3 to about 10%, still more preferably from about 4 to about 8%, and most preferably from about 4 to about 6%, by weight. Additive materials can be selected from the group consisting of a wax, an oil, and mixtures thereof. A preferred additive is a wax or a mixture of an oil (e.g., mineral oil, petroleum jelly, etc.) and a wax. Suitable waxes include various types of hydrocarbons, as well as esters of certain fatty acids (e.g., saturated triglycerides) and fatty alcohols. They can be derived from natural sources (i.e., animal, vegetable or mineral) or can be synthesized. Mixtures of these various waxes can also be used. Some representative animal and vegetable waxes that can be used in the present invention include beeswax, carnauba, spermaceti, lanolin, shellac wax, candelilla, and the like. Representative waxes from mineral sources that can be used in the present invention include petroleum-based waxes such as paraffin, petrolatum and microcrystalline wax, and fossil or earth waxes such as white ceresine wax, yellow ceresine wax, white ozokerite wax, and the like. Representative synthetic waxes that can be used in the present invention include ethylenic polymers such as polyethylene wax, chlorinated naphthalenes such as “Halowax,” hydrocarbon type waxes made by Fischer-Tropsch synthesis, and the like.

When a mixture of mineral oil and wax is utilized, the components will preferably be mixed in a ratio of oil to wax of from about 1:99 to about 7:3, more preferably from about 1:99 to about 1:1, still more preferably from about 1:99 to about 3:7, by weight. In a particularly preferred embodiments, the ratio of oil to wax is about 1:1 or about 3:7, by weight, and the additive is applied at an add-on level of about 5%, by weight. A preferred mixture is a 1:1 mixture of mineral oil and paraffin wax or a 3:7 mixture of mineral oil and paraffin wax.

Particularly enhanced cleaning performance is achieved when macroscopic three-dimensionality and additive are provided in a single cleaning sheet. As discussed hereinbefore, these low levels are especially desirable when the additives are applied at an effective level and preferably in a substantially uniform way to at least one discrete continuous area of the sheet. Use of the preferred lower levels, especially of additives that improve adherence of soil to the sheet, provides surprisingly good cleaning, dust suppression in the air, preferred consumer impressions, especially tactile impressions, and, in addition, the additive can provide a means for incorporating and attaching perfumes, pest control ingredients, antimicrobials, including fungicides, and a host of other beneficial ingredients, especially those that are soluble, or dispersible, in the additive. These benefits are by way of example only. Low levels of additives are especially desirable where the additive can have adverse effects on the substrate, the packaging, and/or the surfaces that are treated.

Other suitable additive materials herein include polymeric additives, especially those with specific adhesive characteristics such as specific Tack Values, Adhesive Work Values, Cohesion/Adhesion Ratios, Stringiness Values, T_{g} Values, and/or molecular weight. The polymeric additive material is selected in order to improve the pick-up of fine particulate matter such as dust, lint, and hair, and especially larger particulate matter typically found on household floors and surfaces such as crumbs, dirt, sand, hair, crushed food, grass clippings and mulch. In addition, the type and amount of the additive material is carefully selected in order to improve particulate pick-up of the cleaning sheet, while maintaining the ability of the cleaning sheet to easily glide across the surface being cleaned. If the cleaning sheet is too tacky as a result of the additives incorporated therein, the cleaning sheet will not easily glide across the surface, leading to consumer dissatisfaction.

Preferred polymeric additives include, but are not limited to, those selected from the group consisting of pressure sensitive adhesives, tacky polymers, and mixtures thereof. Suitable pressure sensitive adhesives comprise an adhesive polymer, which is optionally in combination with a tackifying resin, plasticizer, and/or other optional components. Suitable tacky polymers include, but are not limited to, polyisobutylene polymers, N-decylmethacrylate polymers, and mixtures thereof.

Preferred pressure sensitive adhesives can be selected for incorporation in the present cleaning sheets based on the adhesive characteristics of the pressure sensitive adhesive, including Adhesive Work Value, Tack Value, Cohesive/Adhesive Ratio, and Stringiness Value. These adhesive characteristics, and methods for measuring such adhesive characteristics, have been described in detail in co-pending U.S. application Ser. No. 09/821,953 filed Mar. 30, 2001 by Kacher et al., which is incorporated herein by reference. Preferred polymeric additive materials are also described in detail in said co-pending application.

The substrate of the present invention is preferably free of materials that would diminish the ability of the cleaning sheet to generate an electrostatic charge. An electrostatic charge enhances the ability of the cleaning sheet to remove and retain particulate matter from the surface being cleaned. For example, cationic surfactants, such as fabric softening actives, can diminish the ability of a cleaning sheet to generate electrostatic charge. The present cleaning sheets are thus preferably free of cationic surfactants, such as fabric softening actives.

### Process for Manufacture

The present cleaning sheets can be formed of a variety of process as discussed hereinbefore. An especially preferred process for making a cleaning sheet of the present invention comprises the step of hydroentangling the fibers of the structure on a forming belt having a desired pattern of raised and recessed regions. Examples of such forming belts are described in U.S. Pat. No. 5,275,700, which is incorporated herein by reference. The forming belt can comprise machine-direction warp yarns, cross-machine-direction weft yarns, and a pattern framework. The pattern framework may be formed on the warp and weft yarns by any method known in the art. See, e.g., U.S. Pat. No. 5,275,700. The framework has solid areas and void areas which correspond to the recessed regions and the raised regions, respectively, of the cleaning sheet formed on the belt. The framework of the forming belt has a thickness, and has solid and void areas such that the desired pattern of raised regions will be formed on the cleaning sheet in the hydroentangling process. The framework can have a thickness ranging from about 0.07 mm to about 2.0 mm, preferably from about 0.2 mm to about 1.5 mm, and more preferably from about 0.4 mm to about 0.9 mm. It should be noted that the X-Y dimensions of the raised regions are slightly greater than the width of the form void areas in the form belt. Without being limited by theory, it is believed that during the hydroentangling process the fibers which are pushed into the voids are under compressive force. After hydroentagling, when the sheet is removed from the forming belt, the resulting raised regions will naturally expand, thereby increasing the raised area.

The overall preferred process can be as follows. A layer of nonwoven fiber material is provided and is positioned on a forming belt having a desired pattern to produce a cleaning sheet having macroscopic three-dimensionality. The layer of fibers are then entangled in a hydroentanging unit thereby forming the cleaning sheet. The entangle sheet is then dried. The processes herein can optionally comprise a step wherein the entangled webs are subject to heating, resulting in shrinkage of the substrate in the CD direction and increasing the caliper of the cleaning sheet.

A more preferred process would be as follows. A first fibrous web (or layer), a second reinforcing fibrous web (or layer), and a third fibrous web (or layer) are provided. The first layer is positioned adjacent an upper surface of the reinforcing layer, in face to face relationship with the reinforcing layer. The third layer is positioned adjacent a lower surface of the reinforcing layer, in face to face relationship with the reinforcing layer. The three layers are then placed on a forming belt having a desired pattern. The first layer and the third layer are then entangled in a hydroentanging unit with the reinforcing layer such that portions of the filaments extending between filament intersections remain unbonded to the first layer, and such that portions of the filaments extending between filament intersections remain unbonded to the third layer. The entangled sheet is then dried.

The step of intermittently bonding the reinforcing layer to the first layer and the third layer can comprise the step of heated pressing of the first layer, the reinforcing layer, and third layer at a relatively low pressure for a relatively short time period to avoid relatively continuous bonding of the reinforcing layer to the first and third layers.

III. Cleaning Implements

In another aspect, the present invention relates to a cleaning implement comprising the cleaning sheets discussed herein. In this regard, the cleaning implement comprises a handle, a mop head, and a cleaning sheet of the present invention, wherein the cleaning sheet is removably attachable to the mop head of the cleaning implement.

The handle of the cleaning implement comprises any elongated, durable material that will provide ergonomically practical cleaning. The length of the handle will be dictated by the end-use of the implement.

To facilitate ease of use, the mop head can be pivotably attached to the handle using known joint assemblies. Any suitable means for attaching the cleaning sheet to the support head can be utilized, so long as the cleaning sheet remains affixed during the cleaning process. Examples of suitable fastening means include clamps, hooks & loops (e.g., VELCRO®), and the like. In a preferred embodiment, the mop head will comprise “grippers” on its upper surface to keep the sheet mechanically attached to the mop head during the rigors of cleaning. The grippers will also readily release the sheet for convenient removal and disposable. Preferred grippers are described in co-pending U.S. application Ser. No. 09/374,714 filed Aug. 13, 1999 by Kingry et al., which is incorporated herein by reference.

To further improve glide characteristics and cleaning performance when a present cleaning sheet is attached to a cleaning implement, the mop head of the cleaning implement can have curved profile on the bottom surface of the mop head. Suitable mop heads have curved bottom surfaces are described in co-pending U.S. application Ser. No. 09/821,953 filed Mar. 30, 2001 by Kacher et al., which is incorporated herein by reference.

Suitable cleaning implements are shown in U.S. Design Patent Nos. D-409,343; and D-423,742; which are incorporated herein by reference.

IV. Methods of Use

The present invention further comprises methods of removing particulate matter from a surface comprising the step of contacting the surface with a cleaning sheet of the present invention. The cleaning sheets of the present invention are designed to be compatible with all hard surface substrates, including wood, vinyl, linoleum, no wax floors, ceramic, FORMICA®, porcelain, and the like. They have also been found to be effective on surfaces like walls, ceilings, upholstery, drapes, rugs, clothing, etc., where dusting sheets have not normally been used.

As a result of the ability of the cleaning sheets to reduce, or eliminate, by various means, including contacting and holding, dust, lint and other airborne matter from surfaces, as well as from the air, the sheets will provide greater reduction in the levels of such materials on surfaces and in the atmosphere, relative to other products and practices for similar cleaning purposes. This ability is especially apparent in sheets containing additive materials as described herein. Therefore it is important to provide this information on the package, or in association with the package, so as to encourage the use of the sheets, especially on the non-traditionally dusted surfaces like walls, ceilings, upholstery, drapes, rugs, clothing, etc.

The cleaning sheets herein are also useful for removing residue from glass surfaces, such as fingerprints and other oily residues.

Consumers with allergies especially benefit from the use of the sheets herein, especially the preferred structures, since allergens are typically in dust form and it is especially desirable to reduce the level of small particles that are respirable. For this benefit, it is important to use the sheets on a regular basis, and not just when the soil becomes visually apparent.

The invention also comprises articles of manufacture comprising the cleaning sheets of the present invention, the cleaning sheets being contained in a package in association with instructions for achieving one or more of the following benefits:

captures particulate soils on contact while minimizing dispersal of said soils in the air as compared to normal dusting techniques;

removes more particulate soil than normal dusting techniques;

removes invisible particulate matter;

does not require the application of an additional product;

uses electrostatic charge to pick up very fine particulate soil;

has a macroscopically three-dimensional structure to pick up relatively large particles;

provides surface safety;

lowers the level of particulate material in the air;

reduces the level of particulate soil on a surface;

captures particulate soil on contact while minimizing dispersal of said soil in the air as compared to normal dusting techniques to minimize inhalation of said particulate soil and/or redeposition of said particulate soil;

removes more particulate soil than normal dusting techniques so that your surfaces are cleaner;

does not require the application of an additional product so that the process is simplified.

requires less effort as compared to normal dusting techniques since the particulate soil is more completely removed the first time;

the process collects more particulate soil as compared to normal dusting techniques so that it can be removed from the house or other area;

results in a reduction of airborne allergens; or

results in a reduction of airborne pathogens.

These are packages containing cleaning sheets of the present invention, the packages being in association with information that will inform the consumer, by words and/or by pictures, that use of the sheets will provide the cleaning benefits. In a highly desirable variation, the package bears the information that informs the consumer that the use of the cleaning sheet provides reduced levels of dust and other airborne matter in the atmosphere. It is very important that the consumer be advised of the potential to use the sheets on non-traditional surfaces, including fabrics, pets, etc., to ensure that the full benefits of the sheets is realized. Accordingly, the use of packages in association with information that will inform the consumer, by words and/or by pictures, that use of the compositions will provide benefits such as improved cleaning, reduction of particulate soil in the air, etc. as discussed herein, is important. The information can include, e.g., advertising in all of the usual media, as well as statements and icons on the package, or the sheet itself, to inform the consumer.

### EXAMPLES

The following Examples I-V are non-limiting examples of the cleaning sheets of the present invention.

Each example includes a substrate comprising a first fibrous web, a second fibrous web, and a third reinforcing fibrous web, wherein the first and second fibrous webs are the same material. The first, second, and third fibrous webs are placed on top of a forming belt, with the third reinforcing fibrous web being positioned in between the first fibrous web and the second fibrous web. The forming belt comprises a solid pattern having a thickness of 0.43 mm, in a rounded parallelogram shape having a short diameter length of 4.66 mm a long diagonal length of 7.88 mm. The webs are then hydroentangled and dried. The water entangling process causes the fibers of the first and second fibrous webs to become intertangled and to also become intertangled with the fibers of the reinforcing fibrous web. The resulting substrate is then dried. The substrate is then optionally surface coated (by, e.g., printing, spraying, etc.) with 5%, by weight, of a 3:7 mixture of mineral oil and paraffin wax.

The total aggregate basis weight, CD elongation, and caliper are reported for each cleaning sheet example.

EXAMPLE I

| | |
|---|---|
| First/Second Fibrous Web: | Carded fibrous web having a basis |
| | weight of 26 g/m² and comprising staple |
| | polyester fibers having a denier of 1.5 |
| Third Reinforcing Fibrous Web: | Thermal bonded fibrous web having a |
| | basis weight of 15 g/m² and |
| | comprising polypropylene fibers having |
| | a denier of 2.2 |
| Total Aggregate Basis Weight: | 67 g/m² |
| CD Elongation: | 79% |
| Caliper: | 1.41 mm |

EXAMPLE II

| | |
|---|---|
| First/Second Fibrous Web: | Carded fibrous web having a basis |
| | weight of 28 g/m² and comprising 70% |
| | polyester fibers having a denier of |
| | 1.5, 15% polypropylene fibers having |
| | a denier of 2.2, and 15% of |
| | polypropylene fibers having a denier |
| | of 6.7, by weight of the web |
| Third Reinforcing Fibrous Web: | Thermal bonded fibrous web having a |
| | basis weight of 15 g/m² and |
| | comprising polypropylene fibers having |
| | a denier of 6.7 |
| Total Aggregate Basis Weight: | 71 g/m² |
| CD Elongation: | 102% |
| Caliper: | 1.15 mm |

EXAMPLE III

| | |
|---|---|
| First/Second Fibrous Web: | Carded fibrous web having a |
| | basis weight of 20.5 g/m² and |
| | comprising staple polyester fibers |
| | having a denier of 1.5 |
| Third Reinforcing Fibrous Web: | Thermal bonded fibrous web having a |
| | basis weight of 23 g/m² and |
| | comprising polypropylene fibers having |
| | a denier of 6.7 |
| Total Aggregate Basis Weight: | 64.2 g/m² |
| CD Elongation: | 71% |
| Caliper: | 1.06 mm |

EXAMPLE IV

| | |
|---|---|
| First/Second Fibrous Web: | Carded fibrous web having a |
| | basis weight of 26.7 g/m² and |
| | comprising staple polyester fibers |
| | having a denier of 1.5 |
| Third Reinforcing Fibrous Web: | Spunbonded fibrous web having a |
| | basis weight of 16 g/m² and |
| | comprising polyester fibers having |
| | a denier of 6 |
| Total Aggregate Basis Weight: | 69.4 g/m² |
| CD Elongation: | 11.9% |
| Caliper: | 1.41 mm |

EXAMPLE V

| | |
|---|---|
| First/Second Fibrous Web: | Carded fibrous web having a |
| | basis weight of 25.15 g/m² and |
| | comprising staple polyester fibers |
| | having a denier of 1.5 |
| Third Reinforcing Fibrous Web: | Spunbonded fibrous web having a |
| | basis weight of 15 g/m² and |
| | comprising polyester fibers having |
| | a denier of 2.2 |
| Total Aggregate Basis Weight: | 65.3 g/m² |
| CD Elongation: | 13.5% |
| Caliper: | 1.28 mm |

What is claimed is:

1. A cleaning sheet for removing particulate matter from a surface, said cleaning sheet comprising a substrate comprising a first fibrous web comprising carded staple fibers and a reinforcing fibrous web comprising fibers selected from the group consisting of thermal bonded fibers, meltblown fibers, hydroentangled fibers, and spunbonded fibers; wherein said first fibrous web is hydroentangled with said reinforcing fibrous web to form said substrate; and wherein said cleaning sheet has a CD elongation of less than about 100% at a load of 500 grams.

2. The cleaning sheet of claim 1 wherein said cleaning sheet has a CD elongation of less than about 70% at a load of 500 grams.

3. The cleaning sheet of claim 1 wherein said cleaning sheet has a CD elongation of from about 10% to about 100% at a load of 500 grams.

4. The cleaning sheet of claim 1 wherein said carded staple fibers are polyester fibers and said reinforcing fibrous web comprises spunbonded fibers.

5. The cleaning sheet of claim 4 wherein said spunbonded fibers are selected from the group consisting of polyester fibers, polypropylene fibers, polyethylene fibers, nylon fibers, rayon fibers, and mixtures thereof.

6. The cleaning sheet of claim 5 wherein said spunbonded fibers are polypropylene fibers.

7. The cleaning sheet of claim 1 wherein said reinforcing fibrous web comprises thermal bonded fibers.

8. The cleaning sheet of claim 7 wherein said thermal bonded fibers are selected from the group consisting of polyester fibers, polypropylene fibers, polyethylene fibers, nylon fibers, rayon fibers, and mixtures thereof.

9. The cleaning sheet of claim 8 wherein said thermal bonded fibers are polypropylene fibers.

10. The cleaning sheet of claim 1 wherein said cleaning sheet has a total aggregate basis weight of from about 20 to about 200 g/m2.

11. The cleaning sheet of claim 10 wherein said total aggregate basis weight is from about 40 to about 100 g/m2.

12. The cleaning sheet of claim 11 wherein said total aggregate basis weight is from about 45 to about 80 g/m2.

13. The cleaning sheet of claim 10 wherein said reinforcing fibrous web has a basis weight of from about 5% to about 70% of said total aggregate basis weight.

14. The cleaning sheet of claim 13 wherein said reinforcing fibrous web has a basis weight of from about 10% to about 50% of said total aggregate basis weight.

15. The cleaning sheet of claim 14 wherein said reinforcing fibrous web has a basis weight of from about 15% to about 30% of said total aggregate basis weight.

16. The cleaning sheet of claim 1 wherein said reinforcing fibrous web comprises fibers having a denier of from about 0.5 to about 12.

17. The cleaning sheet of claim 16 wherein said reinforcing fibrous web comprises fibers having a denier of from about 1 to about 6.

18. The cleaning sheet of claim 17 wherein said reinforcing fibrous web comprises fibers having a denier of from about 2 to about 4.

19. The cleaning sheet of claim 1 wherein said first fibrous web comprises first fibers having a denier of from about 0.5 to about 12 and said reinforcing fibrous web comprises second fibers having a denier of from about 0.5 to about 12; wherein the denier of said second fibers is at least 0.5 greater than the denier of said fibers of said first fibers.

20. The cleaning sheet of claim 19 wherein said cleaning sheet has a caliper of from about 0.3 to about 3 mm.

21. The cleaning sheet of claim 1 wherein said cleaning sheet is free of a scrim material.

22. The cleaning sheet of claim 1 wherein said cleaning sheet further comprises an additive material affixed to said substrate.

23. The cleaning sheet of claim 22 wherein said additive material is selected from the group consisting of wax, oil, and mixtures thereof.

24. A cleaning implement for removing particulate matter from a surface, said cleaning implement comprising:
(a) a handle;
(b) a mop head connect to said handle via a joint; and
(c) a cleaning sheet according to claim 1, wherein said cleaning sheet is removably attached to said mop head.

25. A cleaning implement for removing particulate matter from a surface, said cleaning implement comprising:
(a) a handle;
(b) a mop head connect to said handle via a joint; and
(c) a cleaning sheet according to claim 21, wherein said cleaning sheet is removably attached to said mop head.

26. A method of removing particulate matter from a surface, said method comprising the step of contacting said surface with a cleaning sheet according to claim 1.

27. A method of removing particulate matter from a surface, said method comprising the step of contacting said surface with a cleaning sheet according to claim 21.
